(19) United States
(12) Patent Application Publication
(10) Pub. No.: US 2022/0282386 A1
(43) Pub. Date: Sep. 8, 2022

(54) WATER ELECTROLYSIS ELECTRODE CONTAINING CATALYST HAVING THREE-DIMENSIONAL NANOSHEET STRUCTURE, METHOD FOR MANUFACTURING SAME, AND WATER ELECTROLYSIS DEVICE INCLUDING SAME

(71) Applicant: KOREA INSTITUTE OF MATERIALS SCIENCE, Changwon-si (KR)

(72) Inventors: Sung Mook CHOI, Changwon-si (KR); Yoo Sei PARK, Busan (KR); Myeong Je JANG, Cheongju-si (KR); Ju Chan YANG, Changwon-si (KR); Kyu Hwan LEE, Changwon-si (KR); Jeong Hun LEE, Daegu (KR); Sung Min PARK, Busan (KR); Jae Hoon JEONG, Busan (KR)

(21) Appl. No.: 17/637,607

(22) PCT Filed: Oct. 16, 2019
(86) PCT No.: PCT/KR2019/013607

§ 371 Date: Feb. 23, 2022

(30) Foreign Application Priority Data
Sep. 6, 2019 (KR) 10-2019-0111058

(51) Int. Cl. C25B 11/077; C25B 11/031; C25B 1/04

(52) U.S. Cl. CPC C25B 11/0771; C25B 11/031; C25B 1/04

(57) ABSTRACT

The present invention provides a water electrolysis electrode including a catalyst having a three-dimensional nanosheet structure with a low overvoltage and excellent catalytic activity, a method for producing the same, and a water electrolysis device including the same. The water electrolysis electrode according to the present invention includes a catalyst layer, which includes a composite metal oxide and has a three-dimensional nanosheet structure, and an electrode substrate. The method for producing a water electrolysis electrode according to the present invention comprises steps of: immersing an electrode substrate in an electrolyte solution containing metal oxide precursors; electrodepositing composite metal hydroxides by applying a voltage to the electrode substrate; and forming a composite metal oxide by annealing the electrode substrate. The water electrolysis device according to the present invention includes the water electrolysis electrode according to the present invention as an anode.

### TECHNICAL FIELD

This application claims the benefit of the filing date of Korean Patent Application No. 10-2019-0111058, filed with the Korean Intellectual Property Office on Sep. 6, 2019, the entire content of which is incorporated herein.

The present invention relates to a water electrolysis electrode including a catalyst having a three-dimensional nanosheet structure, a method for producing the same, and a water electrolysis device including the same. Specifically, the present invention relates to a water electrolysis electrode having excellent water electrolysis efficiency, a method for producing the same, and a water electrolysis device including the same.

### BACKGROUND ART

Due to the acceleration of global warming caused by the use of carbon-based energy storage devices, the demand for renewable energy has increased. Accordingly, a method of producing electrochemically hydrogen using electrolysis of water has been extensively studied, and the hydrogen produced by this method may be used in a fuel cell or a direct combustion engine.

Electrochemical decomposition of water takes place in two reactions: a hydrogen evolution reaction (HER), and an oxygen evolution reaction (OER). Ideally, a water electrolysis reaction may proceed when a voltage of 1.23 V is applied. However, in practice, due to the influence of surface resistance, etc., an overvoltage of 1.23 V or higher should be applied in order to produce hydrogen by water electrolysis. Thus, it is necessary to reduce the overvoltage for water electrolysis in order to increase the water electrolysis efficiency by reducing the electric energy cost, and hence a catalyst capable of reducing the overvoltage is required in each of the hydrogen evolution reaction and the oxygen evolution reaction.

The performance of a catalyst in water decomposition should be evaluated from two perspectives: hydrogen evolution, and oxygen evolution. Platinum (Pt) is most effective in terms of the hydrogen evolution reaction (HER). In terms of the oxygen evolution reaction (OER), the performance of Pt itself is not significantly superior, and the metal oxide IrO₂ or RuO₂ show high performance.

However, the Ru- and Ir-based catalysts have the disadvantages of being expensive and having poor long-term stability in alkaline media. Accordingly, transition metal oxides, phosphides, borides, etc. that may be used as OER catalysts have attracted attention.

Among them, Co oxide is very suitable as an OER catalyst, but requires a higher overvoltage than the Ru- and Ir-based catalysts. Accordingly, there is a need to find a solution to lower the overvoltage of Co oxide, improve the stability thereof, and improve the OER catalytic activity thereof.

### DISCLOSURE

### Technical Problem

An object of the present invention is to provide a water electrolysis electrode including a catalyst layer that is inexpensive and stable and has excellent catalytic activity, a method for producing the same, and a water electrolysis device including the same.

### Technical Solution

One aspect of the present invention provides a water electrolysis electrode including: an electrode substrate; and a catalyst layer located on the electrode substrate, wherein the catalyst layer includes a composite metal oxide including Cu—X oxide and at least one of Cu oxide and X oxide, and has a three-dimensional nanosheet structure, wherein X is one of Co, Mn, Fe, Ni, V, W, Mo, Pt, Ir, Pd and Ru.

Another aspect of the present invention provides a method for producing a water electrolysis electrode including steps of: forming an electrolyte solution containing a Cu precursor and an X precursor; immersing an electrode substrate in the electrolyte solution; electrodepositing a Cu hydroxide and an X hydroxide on the surface of the immersed electrode substrate; and producing a composite metal oxide including Cu—X oxide and at least one of Cu oxide and X oxide by annealing the electrode substrate having the Cu hydroxide and X hydroxide electrodeposited thereon, wherein X is one of Co, Mn, Fe, Ni, V, W, Mo, Pt, Ir, Pd and Ru.

Still another aspect of the present invention provides a water electrolysis device including the water electrolysis electrode according to the present invention as an anode.

### Advantageous Effects

The water electrolysis electrode according to one embodiment of the present invention may have excellent catalytic activity by including the catalyst layer having an increased surface area. In addition, when the water electrolysis electrode according to one embodiment of the present invention is introduced into a water electrolysis device, it may increase the water electrolysis efficiency because it has a low overvoltage.

### BRIEF DESCRIPTION OF DRAWINGS

FIG. 1 depicts scanning electron microscope (SEM) images of the surfaces of water electrolysis electrodes produced in Example 1, Reference Example 1, Comparative Example 1 and Comparative Example 2.

FIG. 2 shows EDS element mappings of Co and Cu in the catalyst layer material of the water electrolysis electrode produced in Example 1.

FIG. 3 is an SEM image of the cross section of the catalyst layer of the water electrolysis electrode produced in Example 1.

FIG. 4 shows the Raman spectrum of the catalyst layer material of the water electrolysis electrode produced in each of Example 1 and Comparative Example 1.

FIG. 5 shows the XPS spectrum of Cu and Co of the catalyst layer material of the water electrolysis electrode produced in each of Example 1 and Reference Example 1.

FIG. 6 shows LSV polarization curves of the water electrolysis electrodes, produced in Example 1 and Comparative Example 1, and nickel foam including no catalyst layer.

FIG. 7 is a graph showing the potential versus time at a constant current density of 25 mA/cm² or 100 mA/cm² for the water electrolysis electrode produced in Example 1.

FIG. 8 shows LSV polarization curves of the water electrolysis electrode itself produced in Example 1 and the water electrolysis electrode operated at a current density of 25 mA/cm² or 100 mA/cm² for 24 hours.

FIG. 9 shows SEM images of the surface of the water electrolysis electrode produced in Example 1 and operated at a current density of 25 mA/cm² or 100 mA/cm² for 24 hours.

FIG. 10 is a graph showing the potential versus time at a constant current density of 100 mA/cm² for an anion exchange membrane water electrolysis cell into which the water electrolysis electrode produced in Example 1 has been introduced.

FIG. 11 shows a polarization curve of the anion exchange membrane water electrolysis cell, obtained after the water electrolysis electrode produced in Example 1 was introduced into the cell and operated at a constant current density of 100 mA/cm² for 24 hours.

FIG. 12 shows an SEM image of the surface of the anion exchange membrane water electrolysis cell, obtained after the water electrolysis electrode produced in Example 1 was introduced into the cell and operated at a constant current density of 25 mA/cm² for 24 hours.

FIG. 13 shows the XPS spectra of the catalyst layer material of the water electrolysis electrode itself produced in Example 1 and the catalyst layer material of the water electrolysis electrode produced in Example 1 and operated at a current density of 25 mA/cm² for 24 hours.

FIG. 14 shows the XPS spectra of Cu and Co in the catalyst layer material of the water electrolysis electrode produced in Example 1 and operated at a current density of 25 mA/cm² for 24 hours.

### BEST MODE

Throughout the present specification, it is to be understood that when any part is referred to as “including” any component, it does not exclude other components, but may further include other components, unless otherwise specified.

Hereinafter, the present invention will be described in more detail.

The water electrolysis electrode according to the present invention includes: an electrode substrate; and a catalyst layer located on the electrode substrate, wherein the catalyst layer includes a composite metal oxide including Cu—X oxide and at least one of Cu oxide and X oxide, and has a three-dimensional nanosheet structure, wherein X is one of Co, Mn, Fe, Ni, V, W, Mo, Pt, Ir, Pd and Ru.

According to one embodiment of the present invention, the electrode substrate may be in the form of a foam or a plate.

According to one embodiment of the present invention, the expression “catalyst layer located on the electrode substrate” means that, when the electrode substrate is in the form of a plate, the catalyst layer is located on the surface of the electrode substrate, and when the electrode substrate is in the form of a foam, the catalyst layer is located on the surface of a foam located on the surface of the electrode substrate and/or inside the electrode substrate.

When the water electrolysis electrode is introduced into a water electrolysis device, it is preferable to use the electrode substrate in the form of a foam so that an oxygen or hydrogen gas generated by a water electrolysis reaction is easily transported so as to prevent the generated gas from staying on the surface of the catalyst, thereby preventing a significant decrease in the reaction rate by preventing decreases in the surface area of the interface between the electrolyte and the catalyst and in the active sites of the catalyst.

The catalyst layer includes a composite metal oxide including Cu—X oxide and at least one of Cu oxide and X oxide, wherein X is one of Co, Mn, Fe, Ni, V, W, Mo, Pt, Ir, Pd, and Ru. For example, X may be Co. In this case, the catalyst layer may include all of Cu—Co oxide, Cu oxide, and Co oxide, or include Cu—Co oxide and Cu oxide, or include Cu—Co oxide and Co oxide.

According to one embodiment of the present invention, the electrode substrate may include at least one of Ni, SUS, Ti, Au, Cu, ITO and FTO, and may preferably include Ni.

According to one embodiment of the present invention, the catalyst layer includes a three-dimensional nanosheet structure, so that the catalyst layer may have an increased surface area and improved catalytic activity. Specifically, the term “three-dimensional nanosheet structure” refers to a three-dimensional structure formed by three-dimensional growth of nano-sized plate-like nanosheets from the surface of the electrode substrate. Thus, the three-dimensional nanosheet structure may be formed by combining nanosheets in various configurations in a three-dimensional space.

According to one embodiment of the present invention, the thickness of each of the nanosheets may be 20 nm to 30 nm.

The three-dimensional nanosheet structure may be a three-dimensional honeycomb-like structure. Here, the term “three-dimensional honeycomb-like nanosheet structure” may refer to a three-dimensional honeycomb-like structure formed by intersection of plate-like nanosheets grown on the surface of the substrate. When the three-dimensional nanosheet structure has a three-dimensional honeycomb-like structure, the surface area of the catalyst layer may particularly increase, and thus the catalytic activity thereof may be particularly excellent.

According to one embodiment of the present invention, when the three-dimensional nanosheet structure of the catalyst layer has a three-dimensional honeycomb-like structure, the diameter of the unit cell of the three-dimensional honeycomb-like structure may be 100 nm to 300 nm, 200 nm to 300 nm, or 200 nm to 250 nm. When the diameter of the unit cell is within the above numerical range, the surface area of the catalyst may be maximized, and thus the active sites and catalytic activity of the catalyst layer may increase.

According to one embodiment of the present invention, the catalyst layer may have a thickness of 400 nm to 3,000 nm, 500 nm to 3,000 nm, or 1,000 nm to 3,000 nm. When the thickness of the catalyst layer is within the above range, it is possible to prevent the performance of the catalyst layer from being reduced as the catalyst layer is exfoliated or dissolved according to the degradation mechanism during the oxygen evolution reaction, and it is possible to prevent the oxygen evolution activity of the catalyst layer from being lowered due to the lowering of the electrical conductivity resulting from thickening of the non-conductive portion of the catalyst layer.

According to one embodiment of the present invention, the catalyst layer may contain Cu in the composite metal oxide in an amount that decreases away from the side adjacent to the electrode substrate. Specifically, the content of Cu atoms on the catalyst layer side adjacent to the electrode substrate may be higher than the content of Cu atoms on the catalyst layer side not adjacent to the electrode substrate.

According to one embodiment of the present invention, the Cu—X oxide may be CuₓX_{y}O_{z}, wherein x and y may satisfy x+y=3, and z may be 4. When X is Co and the Cu—X oxide has the composition of the above formula, the catalyst may have improved activity and has a stable reverse spinel structure, and as Cu enters a normal spinel structure, Co²⁺ and Co³⁺ ions may coexist, whereby oxygen vacancies may be formed, thus increasing the conductivity and activity of the catalyst.

According to another embodiment of the present invention, the water electrolysis electrode may be produced according to a method including steps of: forming an electrolyte solution containing a Cu precursor and an X precursor; immersing an electrode substrate in the electrolyte solution; electrodepositing a Cu hydroxide and an X hydroxide on the surface of the immersed electrode substrate; and producing a composite metal oxide including Cu—X oxide and at least one of Cu oxide and X oxide by annealing the electrode substrate having the Cu hydroxide and X hydroxide electrodeposited thereon, wherein X is one of Co, Mn, Fe, Ni, V, W, Mo, Pt, Ir, Pd and Ru.

Hereinafter, each step of the method for producing the water electrolysis electrode will be described in detail.

First, an electrolyte solution containing a Cu precursor and an X precursor is formed. The electrolyte solution may further contain a solvent. The electrolyte solution may be formed by adding, to the solvent, the Cu precursor and at least one of a Co precursor, a Mn precursor, a Fe precursor, a Ni precursor, a V precursor, a W precursor, a Mo precursor, a Pt precursor, an Ir precursor, a Pd precursor and a Ru precursor, followed by stirring. The electrolyte solution may contain, in addition to the Cu precursor, various kinds of metal precursors depending on the desired composition of the catalyst layer, including metal sources forming the catalyst layer.

According to one embodiment of the present invention, the Cu precursor and the X precursor may be each independently nitrates, sulfates, chlorides or acetates of Cu and X.

In addition, according to one embodiment of the present invention, the solvent may be water or an organic solvent, and specifically, may be a polar or non-polar organic solvent.

The Cu precursor may be contained in an amount of 10 to 30 parts by weight or 20 to 30 parts by weight based on 100 parts by weight of the X precursor. When the content of the Cu precursor is within the above content range, the three-dimensional nanosheet structure of the catalyst layer may be well maintained, and the catalytic activity of the catalyst layer may not be inhibited.

According to one embodiment of the present invention, an electrode substrate is immersed in the electrolyte solution, and metal hydroxides are formed on the electrode substrate by an electrodeposition method. That is, Cu hydroxide and X hydroxide are electrodeposited.

The term “electrodeposition” means electrical deposition, and is also known as electrolytic plating. The electrodeposition may be performed by a three-electrode system using the electrode substrate as a working electrode.

According to one embodiment of the present invention, the electrodeposition may be performed by applying a voltage of −0.5 V to −1.5 V to the immersed electrode substrate for 3 minutes to 10 minutes. When the electrodeposition is performed within the above voltage range and time range, side reactions may be suppressed, and electrolysis of the solvent further contained in the electrolyte solution may be prevented. In addition, as Cu hydroxide is first electrodeposited, it may serve as a support for the three-dimensional nanosheet structure, and the active surface area may be increased by the three-dimensional nanosheet structure.

According to one embodiment of the present invention, the electrodeposition may be performed at 25° C. to 30° C. When electrodeposition is performed within the above temperature range, appropriate amounts of the catalysts may be electrodeposited without causing side reactions such as electrolyte decomposition.

According to one embodiment of the present invention, electrodeposition of Cu hydroxide occurs in the form of a dendrimer before electrodeposition of X hydroxide. Specifically, since the pH near the electrode may be low and the pH at which Cu is electrodeposited is lower than the pH at which X is electrodeposited, electrodeposition of Cu hydroxide occurs first. The electrodeposited Cu hydroxide may serve as a support for stably maintaining the three-dimensional nanosheet structure of the catalyst layer to be formed later.

According to one embodiment of the present invention, the electrode substrate having the Cu hydroxide and X hydroxide electrodeposited thereon is annealed.

As the electrode substrate having the Cu hydroxide and X hydroxide electrodeposited thereon is annealed, the Cu hydroxide and the X hydroxide may be oxidized to a composite metal oxide including Cu—X oxide and at least one of Cu oxide and X oxide, thereby forming a catalyst layer having a three-dimensional nanosheet structure. In addition, the composite metal oxide formed through the annealing has a lower overvoltage than the metal hydroxides, and thus has excellent catalytic activity for OER.

According to one embodiment of the present invention, the annealing may be performed at a temperature of 200° C. to 400° C. for 30 minutes to 180 minutes. When the annealing is performed within the above temperature range and time range, the conversion rate of the metal hydroxides to the composite metal oxide may increase, and the shape of the three-dimensional structure may be stably maintained.

A water electrolysis device according to another embodiment of the present invention includes the water electrolysis electrode according to the present invention as an anode.

According to one embodiment of the present invention, as the negative electrode and the electrolyte, those that are commonly used in water electrolysis devices may be used.

### MODE FOR INVENTION

Hereinafter, the present invention will be described in detail with reference to examples. However, the examples according to the present invention may be modified into various different forms, and the scope of the present invention is not interpreted as being limited to the examples described below. The examples of the present specification are provided to more completely explain the present invention to those skilled in the art.

### Example 1

An electrolyte solution was prepared by adding Cu(NO₃)₂ (SIGMA-ALDRICH, 98%) and Co(NO₃)₂ (SIGMA-ALDRICH, 98%) to 50 ml of distilled water as a solvent so that the concentration of each is 2 mM and 10 mM, followed by stirring. A nickel foam (ALANTUM, PN05) as an electrode substrate was prepared as a specimen having a size of 0.25 cm 0.25 cm, and then immersed as a working electrode in the prepared electrolyte solution. Meanwhile, a platinum electrode and a calomel electrode (SCE), each prepared to have a size of 4 cm*5 cm, were used as a counter electrode and a reference electrode, respectively. Electrodeposition was performed at 25° C. by applying a voltage of −1 V by a potentiostat (Bio-Logic, VMP3) for 5 minutes. The electrode substrate subjected to the electrodeposition was annealed using a muffle furnace (PLUSKOLAB, CRFM13.u3) at a temperature of 250° C. for 3 hours, thereby producing a water electrolysis electrode.

### Reference Example 1

A water electrolysis electrode was produced in the same manner as in Example 1, except that annealing was not performed.

### Comparative Example 1

A water electrolysis electrode was produced in the same manner as in Example 1, except that an electrolyte solution was prepared by adding of Co(NO₃)₂ (SIGMA-ALDRICH, 98%) to 50 ml of distilled water as a solvent so that the concentration of Co(NO₃)₂ is 10 mM, followed by stirring.

### Comparative Example 2

A water electrolysis electrode was produced in the same manner as in Example 1, except that an electrolyte solution was prepared by adding Cu(NO₃)₂ (SIGMA-ALDRICH, 98%) to 50 ml of distilled water as a solvent so that the concentration of Cu(NO₃)₂ is 2 mM, followed by stirring.

Observation of Surface of Water Electrolysis Electrode and Cross Section of Catalyst Layer

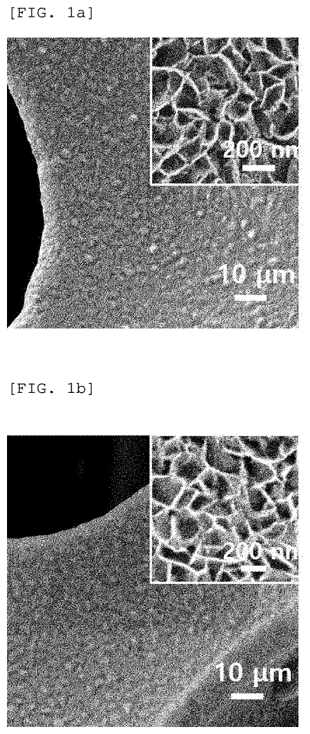

The surface of the water electrolysis electrode produced in each of Example 1, Reference Example 1, Comparative Example 1 and Comparative Example 2 was imaged using a scanning electron microscope (SEM) (JEOL, JSM-7001F), and the SEM images are shown in FIGS. 1a to 1d, respectively. The inset in each figure of FIG. 1 is an enlarged view corresponding to the indicated scale bar.

Referring to FIGS. 1a to 1d, it can be seen that the catalyst layer of Example 1 (FIG. 1a) was formed in a three-dimensional honeycomb shape. On the other hand, it can be confirmed that, in the case of the catalyst layer of Comparative Example 1 (FIG. 1c), the Co oxide layer in the form of a sheet was formed in an overlapping shape because there was no Cu forming a support capable of stably maintaining the three-dimensional nanosheet structure, and in the case of the catalyst layer of Comparative Example 2 (FIG. 1d), a non-uniform catalyst layer in the form of islands was formed. Thus, the water electrolysis electrode according to the present invention has high catalytic activity because the catalyst layer having a three-dimensional elaborate honeycomb shape has a large surface area and many catalytic active sites. In addition, from the SEM image of Example 1, it can be confirmed that the size of the unit cell of the three-dimensional honeycomb structure was about 100 nm to 200 nm.

The catalyst layer of Reference Example 1 (FIG. 1B) corresponds to the catalyst layer before annealing, and it can be seen that the honeycomb shape started to be formed during the electrodeposition process and became more distinct during the annealing process.

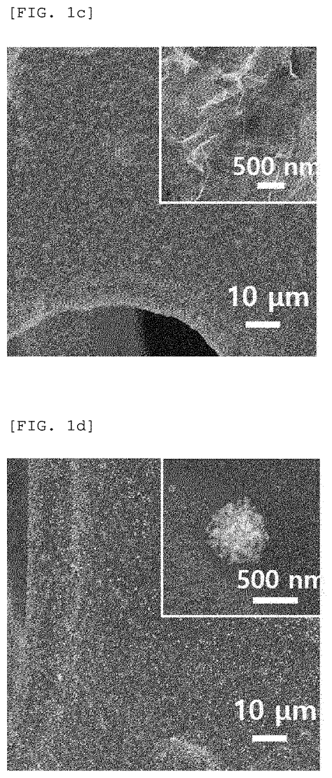

FIG. 2 shows EDS element mappings of Co and Cu in the catalyst layer material of the water electrolysis electrode produced in Example 1.

Referring to FIG. 2, it can be confirmed that, in the catalyst layer of the water electrolysis electrode produced in Example 1, the metal elements used to form the catalyst layer were uniformly distributed.

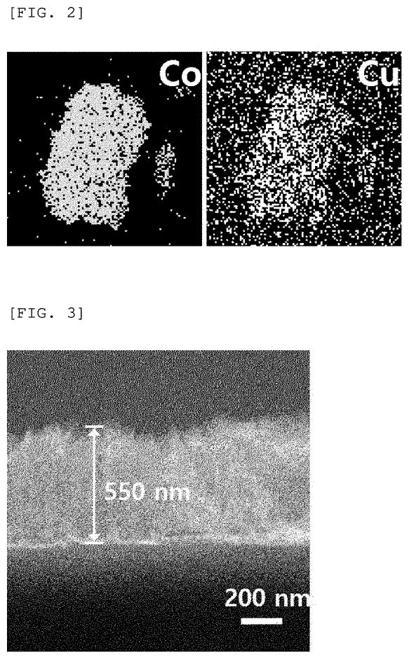

In addition, the cross section of the catalyst layer of the water electrolysis electrode produced in Example 1 was imaged using a scanning electron microscope (SEM) (JEOL, JSM-7001F), and the SEM image is shown in FIG. 3.

Referring to FIG. 3, it can be confirmed that the thickness of the catalyst layer of the water electrolysis electrode produced in Example 1 was about 550 nm.

Analysis of Composition of Water Electrolysis Electrode

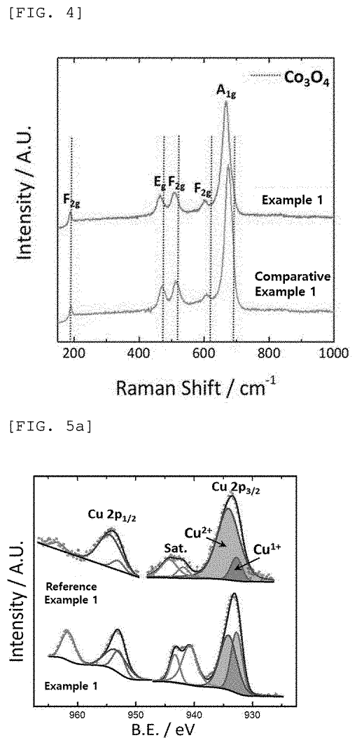

The Raman spectrum of the catalyst layer material of the water electrolysis electrode produced in each of Example 1 and Comparative Example 1 was measured using a Raman spectrometer (JASCO, NRS-3300), and the results are shown in FIG. 4.

Referring to FIG. 4, the Raman spectrum of Comparative Example 1 had a Raman peak slightly shifted toward a shorter wavelength from the original Co₃O₄ peak, but the Raman spectrum of Example 1 had a Raman peak more shifted toward a shorter wavelength from the original Co₃O₄ peak than that of Comparative Example 1. This suggests that Cu was incorporated to form CoₓCu₃₋ₓO₄.

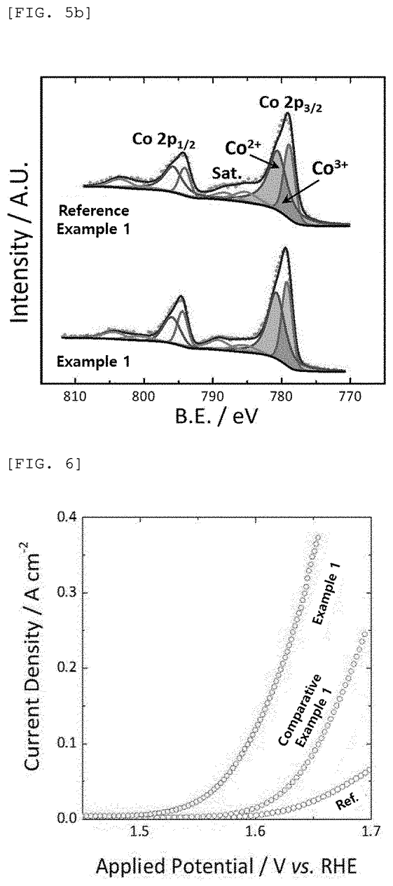

XPS spectra of Cu and Co in the catalyst layer material of the water electrolysis electrode produced in each of Example 1 and Reference Example 1 were measured using an X-ray photoelectron spectrometer (Thermo Scientific, VG Multilab 2000), and the results are shown in FIGS. 5a and 5b, respectively.

Referring to FIG. 5a, Cu of the water electrolysis electrode produced in Reference Example 1 had a composition including Cu+ and Cu²⁺ at 13:87, and Cu of the water electrolysis electrode produced in Example 1 had a composition including Cu+ and Cu²⁺ at 40:80.

Referring to FIG. 5b, Co of the water electrolysis electrode produced in Reference Example 1 had a composition including Co²⁺ and Co³⁺ at 66:34, and Co of the water electrolysis electrode produced in Example 1 had a composition including Co²⁺ and Co³⁺ at 61:39.

That is, referring to FIGS. 4, 5a, and 5b, it can be seen that the water electrolysis electrode produced in Reference Example 1 included CuOH, Cu(OH)₂ and Co(OH)₂, and in the case of the water electrolysis electrode produced in Example 1 through the annealing process, the Co hydroxide and the Cu hydroxide were transformed into Cu_{0.81}Co_{2.19}O₄, and excess Cu was precipitated as Cu oxide (Cu₂O).

That is, it can be confirmed that the metal hydroxides were converted into a composite metal oxide in the annealing step.

Measurement and Evaluation of Overvoltage of Water Electrolysis Electrode

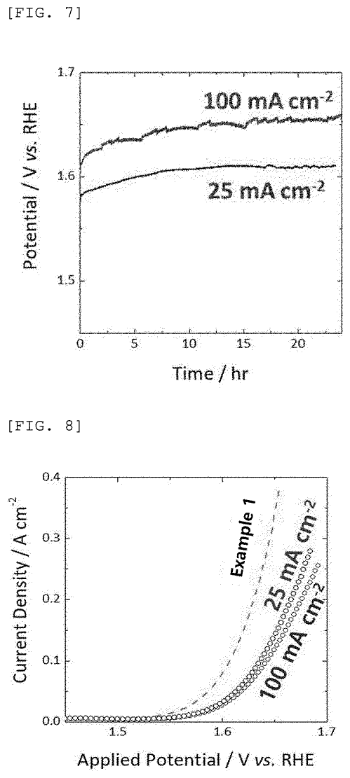

To the water electrolysis electrode produced in each of Example 1 and Comparative Example 1 and the nickel foam (Reference) including no catalyst layer, a voltage was applied using linear sweep voltammetry (LSV) by a potentiostat (Bio-Logic, VMP3) at room temperature at a scanning rate of 5 mV/s. The LSV polarization curve corresponding to the current density versus the applied voltage is shown in FIG. 6.

Referring to FIG. 6, Example 1 showed an overvoltage of 290 mV at a current density of 10 mA/cm². On the other hand, Comparative Example 1 showed an overvoltage value of 420 mV, which was higher than that of Example 1, at a current density of 10 mA/cm². Therefore, it can be seen that the water electrolysis electrode according to the present invention shows a relatively low overvoltage by clearly having a three-dimensional nanosheet structure having a three-dimensional honeycomb-like structure, and thus when it is introduced into a water electrolysis device, it may exhibit excellent water electrolysis efficiency while having excellent catalytic activity even at a lower voltage.

Long-Term Stability Test for Water Electrolysis Electrode

Half Cell Test

While the water electrolysis electrode produced in Example 1 was operated in a 1M KOH electrolyte solution at a constant current density of 25 mA/cm² or 100 mA/cm² for 24 hours, the voltage was measured using chronopotentiometry. A graph corresponding to the voltage versus time is shown in FIG. 7.

Referring to FIG. 7, it can be confirmed that, even when the water electrolysis electrode produced in Example 1 was operated at a current density of 25 mA/cm² for 24 hours, it showed an increase in overvoltage of only 90 mV compared to that in the initial operation, and even when the water electrolysis electrode was operated at a current density of 100 mA/cm², the increase in overvoltage was not significant, suggesting that the long-term stability of catalytic activity of the water electrolysis electrode was excellent.

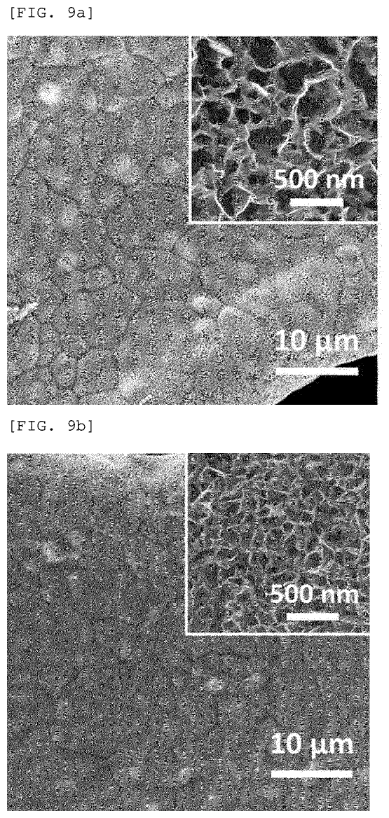

In addition, after the water electrolysis electrode produced in Example 1 was operated in a 1M KOH electrolyte solution at a current density of 25 mA/cm² or 100 mA/cm² for 24 hours, a voltage was applied thereto using linear sweep voltammetry (LSV) by a potentiostat (Bio-Logic, VMP3) at room temperature at a scanning rate of 5 mV/s. LSV polarization curves corresponding to the current density versus the applied voltage are shown in FIG. 8.

Referring to FIG. 8, it can be confirmed that, when the water electrolysis electrode produced in Example 1 was operated at a current density of 25 mA/cm² for 24 hours, it showed an increase in overvoltage of only 40 mV compared to the initial overvoltage of the water electrolysis electrode, and when the water electrolysis electrode was operated at a current density of 100 mA/cm² for 24 hours, it showed an increase in overvoltage of only 50 mV, suggesting that the long-term stability of catalytic activity of the water electrolysis electrode was excellent.

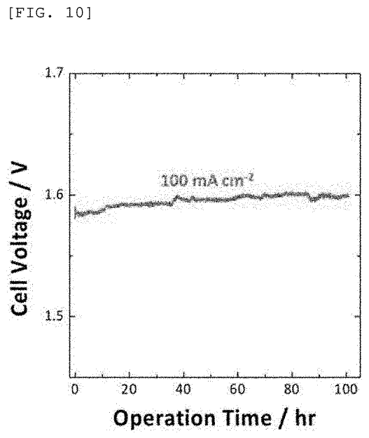

In addition, after the water electrolysis electrode produced in Example 1 was operated in a 1M KOH electrolyte solution at a current density of 25 mA/cm² or 100 mA/cm₂ for 24 hours, the surface of the water electrolysis electrode was imaged using a scanning electron microscope (SEM) (JEOL, JSM-7001F), and the SEM images are shown in FIGS. 9a and 9b, respectively.

Referring to FIGS. 9a and 9b, it can be confirmed that, even when the water electrolysis electrode produced in Example 1 was operated for 24 hours, the three-dimensional honeycomb-like structure thereof was maintained. Thus, it can be confirmed that the long-term stability of the large catalytic surface area of the water electrolysis electrode according to the present invention is high.

Full Cell Test

The long-term stability of the water electrolysis electrode produced in Example 1 was tested by introducing the water electrolysis electrode into an anion exchange membrane water electrolysis cell (AWMWE) containing a 0.1M KOH electrolyte solution.

The anion exchange membrane water electrolysis cell included a gas outlet, an anion exchange membrane for gas separation, and an external device for promoting the circulation of the electrolyte solution, and the test was performed using the water electrolysis electrode produced in Example 1 as an anode, Pt/C as a cathode, and 0.1M KOH as an electrolyte solution.

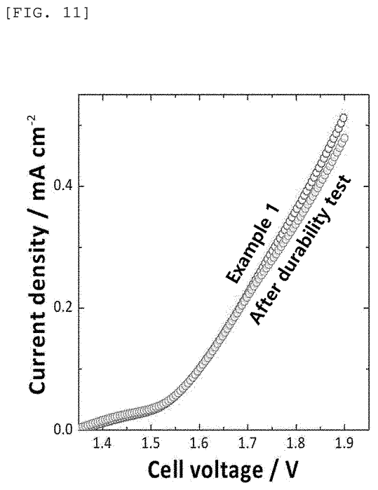

While the anion exchange membrane water electrolysis cell into which the water electrolysis electrode produced in Example 1 has been introduced was operated at a temperature of 30° C. at a constant current density of 100 mA/cm² for 100 hours, the cell voltage was measured using chronopotentiometry. A graph corresponding to the voltage versus time is shown in FIG. 10.

Referring to FIG. 10, it can be confirmed that, even when the water electrolysis electrode produced in Example 1 was introduced into the water electrolysis cell and operated at a constant current density of 100 mA/cm² for about 100 hours, the overvoltage after 100 hours increased by only 20 mV compared to the initial overvoltage (350 mV), and thus did not significantly change. That is, it can be confirmed that the long-term stability of catalytic activity of the water electrolysis electrode according to the present invention is high.

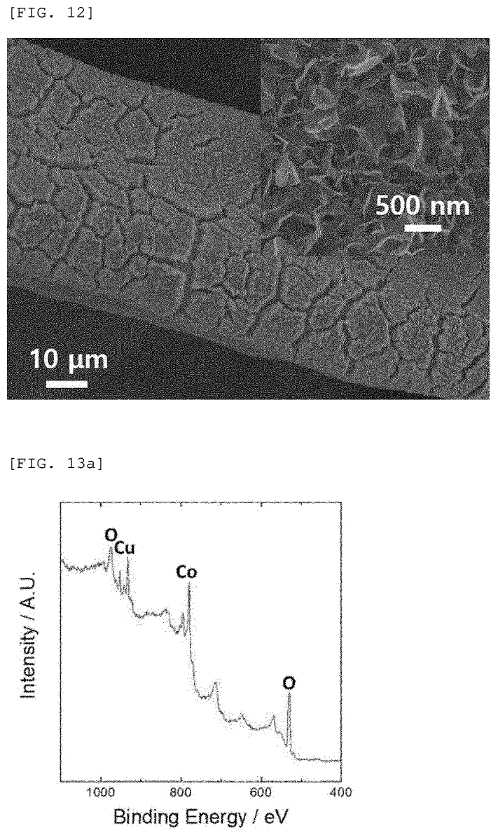

In addition, FIG. 11 shows polarization curves corresponding to the current density versus the voltage applied by a potentiostat (WonaTech, ZIVE MP5) device to each of the anion exchange membrane water electrolysis cell, into which the water electrolysis cell produced in Example 1 was introduced, and the anion exchange membrane water electrolysis cell operated at a constant current density of 25 mA/cm² or 100 mA/cm² for 24 hours.

Referring to FIG. 11, it can be confirmed that, even when the water electrolysis electrode produced in Example 1 was operated at a constant current density of 100 mA/cm² for 24 hours, the electrochemical properties thereof did not deteriorate. Thus, it can be confirmed that the long-term stability of catalytic activity of the water electrolysis electrode according to the present invention is high.

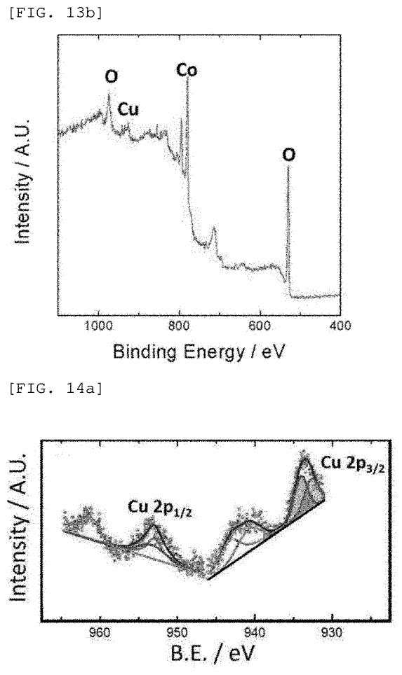

In addition, after the water electrolysis electrode produced in Example 1 was introduced into an anion exchange membrane water electrolyte cell and operated using a potentiostat (WonaTech, ZIVE MP5) at a constant current density of 25 mA/cm² for 24 hours, the surface of the water electrolysis electrode was imaged using a scanning electron microscope (SEM). The SEM image is shown in FIG. 12.

Referring to FIG. 12, it can be confirmed that, even when the water electrolysis electrode produced in Example 1 was operated at a constant current density of 25 mA/cm² or 100 mA/cm² for 24 hours, the three-dimensional honeycomb-like structure thereof was maintained. Thus, it can be confirmed that the long-term stability of the large catalyst surface area of the water electrolysis electrode according to the present invention is high.

Examination of Change in Composition of Water Electrolysis Electrode after Long-Term Stability Test

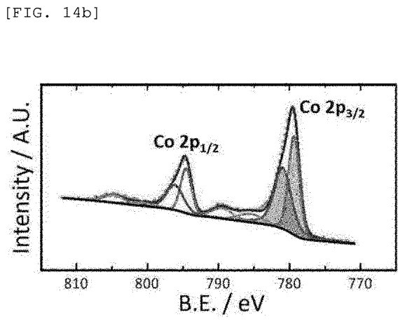

The XPS spectrum of the catalyst layer material of the water electrolysis electrode produced in Example 1 was measured using an X-ray photoelectron spectrometer (Thermo Scientific, VG Multilab 2000), and a graph showing the XPS spectrum is shown in FIG. 13a.

In addition, after the water electrolysis electrode produced in Example 1 was operated in a 1M KOH electrolyte solution at a constant current density of 25 mA/cm² for 24 hours, the XPS spectrum of the catalyst layer material of the water electrolysis electrode was measured using an X-ray photoelectron spectrometer (Thermo Scientific, VG Multilab 2000). A graph showing the XPS spectrum is shown in FIG. 13b.

Referring to FIGS. 13a and 13b, it can be confirmed that, when the water electrolysis electrode produced in Example 1 was operated in a 1M KOH electrolyte solution at a constant current density of 25 mA/cm² for 24 hours, the peak of Cu significantly decreased.

In addition, after the water electrolysis electrode produced in Example 1 was operated in a 1M KOH electrolyte solution at a constant current density of 25 mA/cm² for 24 hours, the XPS spectra of Cu and Co in the catalyst layer material of the water electrolysis electrode were measured using an X-ray photoelectron spectrometer (Thermo Scientific, VG Multilab 2000). The XPS spectra are shown in FIGS. 14a and 14b.

Referring to FIGS. 14a and 14b, it can be confirmed that, after the water electrolysis electrode produced in Example 1 was operated in a 1M KOH electrolyte solution at a constant current density of 25 mA/cm² for 24 hours, the peak of Co in the XPS spectrum did not significantly differ from those in FIGS. 4a and 5b, but the peak of Cu peak definitely decreased.

Taking FIGS. 13 and 14 together, it can be seen that, as the operation time of the water electrolysis electrode produced in Example 1 increases, the catalytic activity thereof decreases due to the dissolution of Cu.

1. A water electrolysis electrode comprising:
an electrode substrate; and
a catalyst layer located on the electrode substrate,
wherein the catalyst layer comprises a composite metal oxide comprising Cu—X oxide and at least one of Cu oxide and X oxide, and has a three-dimensional nanosheet structure, wherein X is one of Co, Mn, Fe, Ni, V, W, Mo, Pt, Ir, Pd and Ru.

2. The water electrolysis electrode of claim 1, wherein the electrode substrate is in the form of a foam or plate.

3. The water electrolysis electrode of claim 1, wherein the electrode substrate comprises at least one of Ni, SUS, Ti, Au, Cu, ITO and FTO.

4. The water electrolysis electrode of claim 1, wherein the catalyst layer has a thickness of 400 nm to 3,000 nm.

5. The water electrolysis electrode of claim 1, wherein the Cu—X oxide is CuₓX_{y}O_{z}, wherein x and y satisfy x+y=3, and z is 4.

6. The water electrolysis electrode of claim 1, wherein the three-dimensional nanosheet structure of the catalyst layer has a three-dimensional honeycomb-like structure.

7. The water electrolysis electrode of claim 6, wherein a unit cell of the three-dimensional honeycomb-like structure has a diameter of 100 nm to 300 nm.

8. A method for producing a water electrolysis electrode comprising steps of:
forming an electrolyte solution containing a Cu precursor and an X precursor;
immersing an electrode substrate in the electrolyte solution;
electrodepositing a Cu hydroxide and an X hydroxide on a surface of the immersed electrode substrate; and
producing a composite metal oxide comprising Cu—X oxide and at least one of Cu oxide and X oxide by annealing the electrode substrate having the Cu hydroxide and X hydroxide electrodeposited thereon,
wherein X is one of Co, Mn, Fe, Ni, V, W, Mo, Pt, Ir, Pd and Ru.

9. The method of claim 8, wherein the Cu precursor and the X precursor are each independently nitrates, sulfates, chlorides or acetates of Cu and X.

10. The method of claim 8, wherein the Cu precursor is contained in an amount of 10 to 30 parts by weight based on 100 parts by weight of the X precursor.

11. The method of claim 8, wherein the step of electrodepositing is performed by applying a voltage of −0.5 V to −1.5 V to the immersed electrode substrate for 3 minutes to 10 minutes.

12. The method of claim 8, wherein the annealing is performed at a temperature of 200° C. to 400° C. for 30 minutes to 180 minutes.

13. A water electrolysis device comprising, as an anode, the water electrolysis electrode according to claim 1.
